(19) United States
(12) Patent Application Publication
(10) Pub. No.: US 2003/0144961 A1
(43) Pub. Date: Jul. 31, 2003

(54) System and method for the creation and distribution of customized electronic books

(76) Inventors: Ajit C. Tharaken, New York, NY (US); Michael D. Angle, Warwick, NY (US)

Correspondence Address: Evan Bundis, ORRICK, HERRINGTON & SUTCLIFFE LLP, 666 Fifth Avenue, New York, NY, 10103-0001, US

(21) Appl. No.: 10/059,067

(22) Filed: Jan. 25, 2002

(51) Int. Cl. H04K 1/00; H04L 9/00; G06F 17/60

(52) U.S. Cl. 705/57; 705/51; 705/53

(57) ABSTRACT

A system and method for the creation and distribution of customized electronic books which include source content from one or more disparate data sources. Multiple sets of rules can be utilized to filter the types of content to be included in the book as well as to customize the assembly and production of the book itself. The rules can be set by the user of the system or method, or by a company employing the user on a company-wide basis. The source materials for the book content include data provided by the system itself, data accessed from third parties, and data which is provided by the user. Once the topic and content for the book are selected by the user, the content is retrieved, formatted into a single format, assembled into a completed product per the applicable rules, and delivered to the user or a third party for printing. The user can email the book in electronic format to other locations or individuals, or print the completed book in hard copy format for review.

### FIELD OF THE INVENTION

This invention relates generally to a system and method for the creation and distribution of customized electronic books that include content from one or more data sources. More particularly, this inventions relates to a system and method whereby a user can quickly and efficiently search for and select content from an array of sources hosted in different locations, retrieve the content, package the content, and create an electronic book. Additionally, the invention relates to an electronic book that can be created through the implementation of one or more levels of user-defined customizing rules, which can be set on an individual or group basis.

### BACKGROUND OF THE INVENTION

In many fields of business, there is a need by those in the field for books containing a variety of information on a particular topic, industry, company or set of companies. These information books, often used by bankers to create acquisition and investment ideas for financial buyers and sellers, or consultants to quickly learn about a client and their business, are often referred to as briefing books, pitch books, and the like. A typical book for use in the financial sector often contains different sections such as Investment Research, Research News, United States Securities and Exchange Commission (“SEC”) Disclosure Documents, Company Snapshots, Recent Stock Price Charts, Ownership Profiles, Shareholding Data, Recent Merger & Acquisition Data, and New Issues. Historically, these books have been created by analysts or information professionals such as corporate librarians who are trained and are experts as to the types of information that goes into these books, as well as the format required for the proper stylized presentation of the books.

The main drawback of the current system is the large amount of time required to search for and choose the necessary data content from the various sources, and to format, order and assemble the content to fit in the finished product. This highly manual and tedious process typically takes between six and eight hours for a trained professional to complete. Further drawbacks include the expense of hiring trained professionals to conduct the process, and the inconvenience to the user, who must convey to the professional what content is required.

Known internet search engines make the process of searching for and retrieving information much easier for these trained professionals. For example, search engines such as those located at www.yahoo.com or www.google.com allow for faster searches of multiple on-line sources, and various other internet search products utilize complex mathematical algorithms to perform more intelligent and faster searches for a user. Additionally, other internet products such as a personalized newspapers offered on the Wall Street Journal® or Yahoo!® websites, allow the user to specify certain desired types of information to be delivered to the user.

However, none of the aforementioned search engines or web products provide for an efficient and comprehensive mechanism of retrieving content from multiple sources, including content resident on the user's own computer system or intranet, packaging and assembling that content into a customized book, and delivering the finished book to the user. Also, none of these known products allow a user to specify multiple levels of rules, including rules for selecting among the multiple sources, rules for selecting content from within those sources, and rules for defining and customizing the final book. Thus, these known products do not provide for the automated publication of customized books such as briefing books, nor do they provide a means by which books can be customized by a company for all of its employees on a company-wide basis.

### OBJECT AND SUMMARY OF THE INVENTION

It is, therefore, an object of the present invention to provide for a system and method for the creation, packaging, and distribution of customized books based on a system of pre-defined rules customized to a user's specifications, which is faster and more efficient than current known systems and methods.

It is another object of the present invention to provide an automated system and method for creating customized books wherein the job of searching for, filtering, and selecting the content for the book does not require the services of trained professionals to coordinate and undertake the process manually.

It is a further object of the present invention to provide a system and method for creating customized books wherein the look and feel for each customized book is standardized both on an individual level, as well as on a corporate level.

It is another object of the present invention to provide a system and method for creating customized books containing content from various sources, including content from databases resident on the system creating the book, content resident on systems operated by third parties, and content resident on a user's own system.

Broadly, the present invention provides a computerized system and method for the creation, packaging, and distribution of customized books containing content retrievable from a variety of different sources. The subject of the book can be a single company, a set of companies, an industry, or any other particular topic of interest. Although an embodiment of the present invention described below is tailored to the creation of financial information books known as pitch books or briefing books, the method and system can be used to create customized books on any defined topic.

When used to create briefing books, the content sources to be retrieved by a system according to the invention includes various types of sources containing company, industry, and financial information such as archival company news, SEC filings, scanned images of annual reports, earning estimates, M&A profiles, shareholding data, investment research, company web pages, internal proprietary research and third party web pages.

The data content for a book created according to an embodiment of the invention can be obtained from any of a variety of sources. Such sources include: (i) content hosted by the system generating the book; (ii) content hosted outside of the system and accessed via API (an Application Programming Interface which is a defined function call or communications protocol between two systems and which may be a proprietary interface, unique to a single hosting system, or may be a standard interface); (iii) content retrievable from an end user via a web browser; and (iv) content hosted outside of the system and accessed via a URL (uniform resource locator).

According to an embodiment of the invention, a user follows several steps to create their customized book. In the first step, the user provides various identifying information for the book. This includes information such as a book name, client name, project code, and billing information. In the second step, the user identifies a specific company, set of companies, industry, or other topic that is to be the subject of the book.

In the third step, the user selects the customized data content to appear in the book. According to one embodiment, wherein a user works for an organization, predetermined content selection rules that apply to all users working for that organization are stored. According to a further embodiment, wherein a user has set predetermined content selection rules applying only to that particular user, those predetermined rules are also stored.

In other words, once the user has selected a particular topic for the book, the system presents a list of content that may be added to the book based on those predetermined content selection rules. The predetermined rules can be stored in a user settings database contained in the system itself or, alternatively, stored on the user's computer. The predetermined rules can specify, for example, data content sources, data content filters by source, table of contents ordering and specifications, cover sheet specifications, separator pages, user default directories, custom logos, book expiration times, and pricing information. According to another embodiment, the user may perform free-form searches across the available data sources and direct the system to add any content that is found to the book.

In the fourth step, the user submits the identifying information and the selected content for production and the system creates a customized book, assembling the content according to a farther set of predetermined assembly and formatting rules, if such rules have been specified. These further rules also may be specified individually by the user or may be set on an organization-wide basis. The system also creates a customized table of contents identifying the assembled content.

During this fourth step, the selected data content is first retrieved from the specified sources. If the retrieved data content exists in multiple formats, all the data content is converted into a single format and a final document is created and assembled according to the predetermined rules. Also, during this step, publishing instructions, such as directions for the insertion of separator pages, customized covers, binding instructions and the like are generated and added to the book. According to one embodiment, the book creation process is accomplished on the user's machine. According to another embodiment, the book creation process is accomplished on a shared data server with archiving abilities.

In the fifth step, the system delivers the completed book either directly to the user or to a third party such that the book, including the customized table of contents and, if desired, pre-printed covers, bindings, and separator pages, can be printed out in hard-copy format and assembled based on the formatting instructions generated by the system. If the book has been created on a server, an email or other form of notification is sent to the user or the third party to indicate that the book is completed. The completed book is obtained by clicking on a web link included in an email message, by clicking on an attachment to an email, or by signing into the system and downloading the book.

### BRIEF DESCRIPTION OF THE DRAWINGS

Further characteristics, features, and advantages of the present invention will be apparent to a person of ordinary skill in the art upon consideration of the following detailed description, taken in conjunction with the following drawings, in which like reference numerals refer to like elements, and in which:

FIG. 1 is a flow chart illustrating the book identification process according to an embodiment of the present invention;

FIGS. 2 is a flow chart illustrating the subject matter selection process according to an embodiment of the present invention;

FIGS. 3 is a flow chart illustrating the customized data content selection process according to an embodiment of the present invention;

FIGS. 4 is a flow chart illustrating the book creation process according to an embodiment of the present invention; and

FIG. 5 is a flow chart illustrating the completed book delivery process according to an embodiment of the present invention.

### DETAILED DESCRIPTION OF THE DRAWINGS

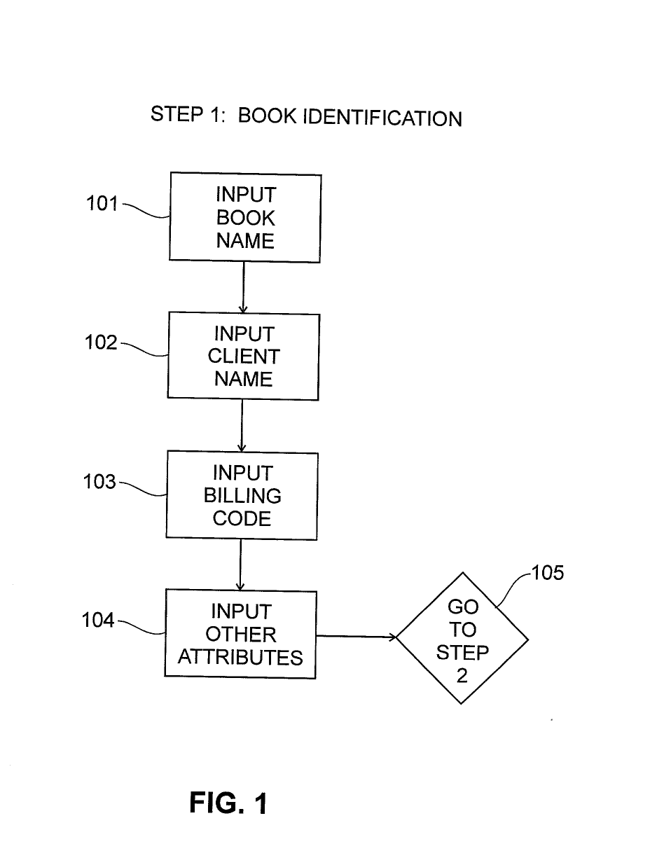

According to the present invention, with reference to FIGS. 1-4, a system and method are disclosed for the creation, packaging and distribution of books customized from content obtained from one or more sources. These sources may include, for example, the system itself, third party content providers, and the end user of the system.

According to one embodiment, the system consists of two applications. The first application is a user application that allows a user to create a customized book based on that user's preferences and various pre-defined rules. In the preferred embodiment, this application is web-based, running behind a World-Wide-Web server and interfacing with the user via a standard Web Browser such as Microsoft Internet Explorer®. In other embodiments, this application is run directly on the user's computer system and interfaces with them directly through a graphical user interface.

The second application is a book packager application that provides the mechanism for assembling the book according to other pre-defined rules. This application contains the logic to fetch documents, convert the documents into a standardized format, and construct meta pages such as a Table of Contents, Cover Pages and Separator Pages. In the preferred embodiment, this application is server based, running on a shared server between a number of users. In other embodiments, this application is run on the user's computer system or is integrated into the user application.

The book packager application performs its function in two steps. First, the customized data content selected by the user is retrieved for the book and the content is formatted into a single format. Second, the book is assembled according to the user's specified configuration. Notification is then sent to the user when the book is complete, and the completed book is delivered, or otherwise made available to the user.

The User Application

The Log-In Process

According to one embodiment of the invention, an end user of the system accesses the user application via a web browser such as Netscape Navigator® or Microsoft's Internet Explorer®. Alternatively, the user application is housed on a user's computer and the user runs the application locally.

According to this embodiment, the user logs into the system using a username and password which have previously been provided to the user. For a new user, the system solicits various information from the user and a username and password are provided once the user has provided this information. The user information may be stored on the user's computer, enabling the user to enter directly into the system with a single sign-on and eliminating the need for the user to log in each time the system is accessed.

According to one embodiment, during the log-in process, a corporate user is prompted to enter credentials, such as one or more project codes. These project codes may be validated against a list of valid codes provided at a corporate level. Such a list can be updated at any time. This can be done through the user application, where a user with sufficient entitlements may add, delete or edit any project codes on the list, or, alternatively, the update may be done as a batch update, where a file containing all valid codes is used to update the list. This file may be provided through a number of mechanisms such as FTP (File Transfer Protocol), HTTP (HyperText Transfer Protocol), or email.

Alternatively, project codes are validated against a regular expression which is provided at a corporate level. This option allows the application to validate the format (but not the content) of the entered code. For example, a regular expression can be used to ensure that a code consists of three letters followed by three digits. These regular expressions can also be more sophisticated, allowing only certain combinations of letters or numbers to be validated, such that the software can perform without the burden of the user providing a complete list of valid codes.

Once the user has successfully logged into the system, the user is prompted to select what type of activity to undertake. These activities may include viewing usage statistics, entering user settings, creating a new book, continuing work on an existing book, and retrieving an already assembled book.

Viewing Usage Statistics

According to one embodiment of the invention, the user can view various statistics regarding usage of the system by entering the “View Statistics” section of the system. Usage statistics include information such as previous books completed, log-on dates, previous client information, book prices, and the like. Usage statistics may be automatically updated by the system after each use of the system by a particular user.

Entering User Settings

Rules for the presentation of content sources to the user, for filtering the results of content retrieved from content sources, for assembling and formatting the finished book, and for generating a customized table of contents are solicited as one or more user settings. The content selection rules, assembly rules and formatting rules may be stored in a user settings database housed on a shared data server. Alternatively, the user settings may be stored on a user's computer through which the system is accessed. User settings include, without limitation, defined information such as preferred data content sources, data content filters by source, table of contents format and ordering, project codes (with or without validation), cover sheet preferences, separator pages preferences, user default directories, custom logos, book expiration times, pricing options, data source naming conventions, and the like. According to one embodiment, the user can change the user settings at any time. Alternatively, the user settings can only be changed at a organization-wide level. According to another embodiment, default rules are set on a user firm-wide basis and an individual user can elect to accept all the default rules, using a one-click, single-step set-up, and create a book without the need to individually set user preferences or review content to be added to the book.

According to one embodiment, at the time a user starts the user application, user preferences are loaded from the database based on a user identification or account identification set for that user. Preferences at the user identification level have precedence over preferences set at the account level. This allows common preferences to be set at the account level, with preferences specific to a given user to be set at the user level. For example, where most users at a user firm are to be configured to search for Securities and Exchange Commission filings from a single source, this preference is set at the account level. Since only a few users at the firm will need to select filings from other sources, this preference will be set individually at the user level.

Create A New Book/Work On An Existing Book

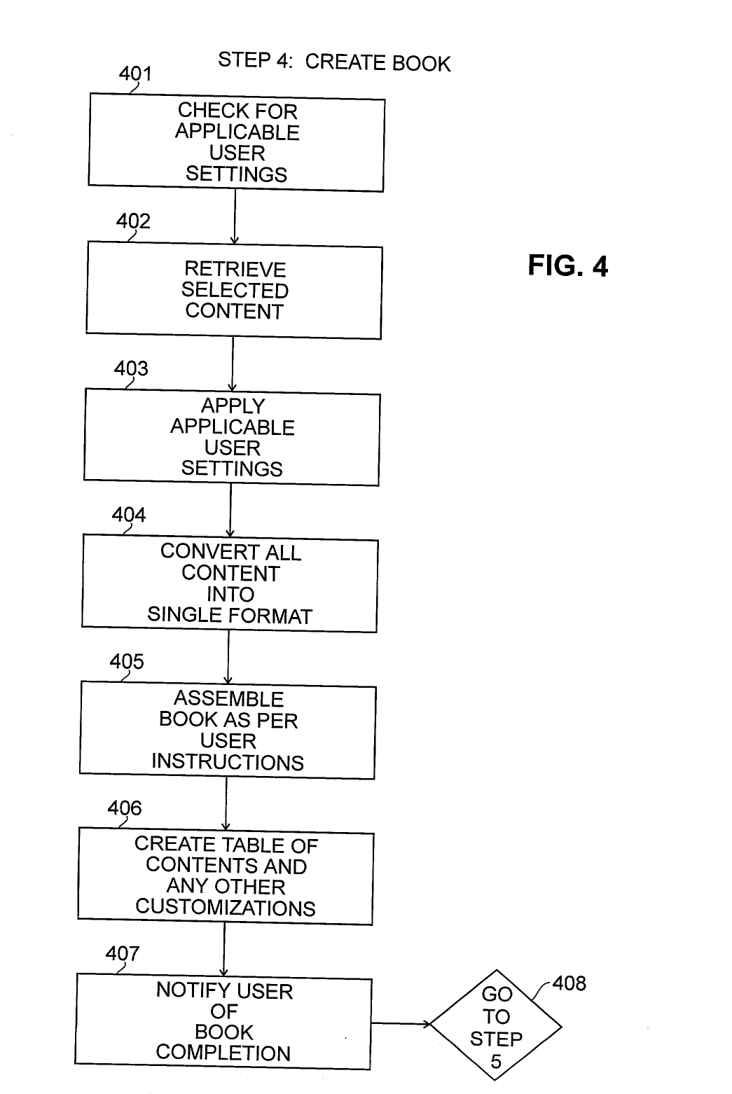

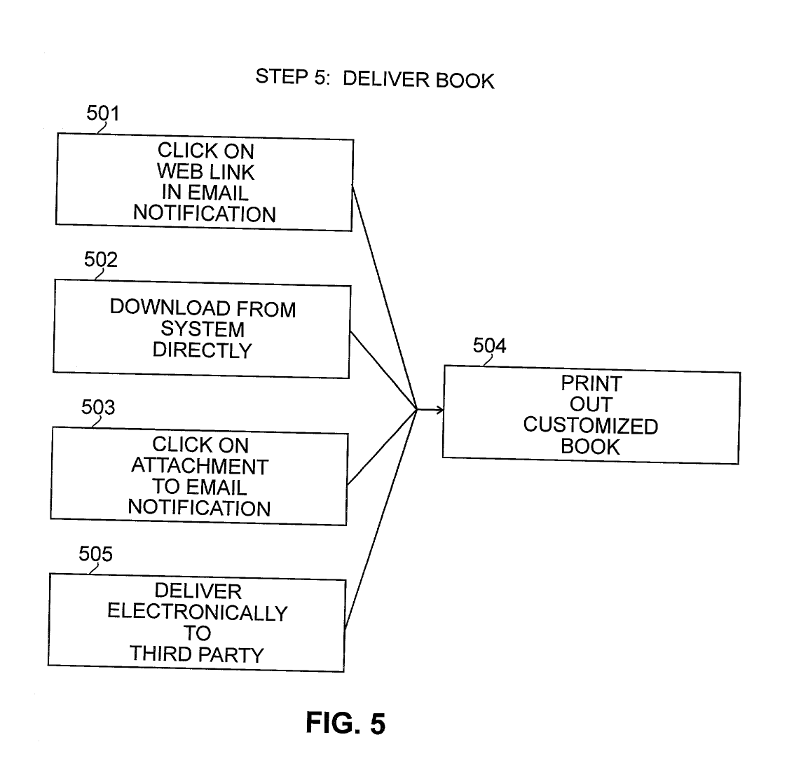

According to the embodiment illustrated in FIGS. 1-5, the new book creation process comprises five steps. The first three steps, shown in FIGS. 1-3, comprise the user application through which the customized content for the book is selected, and the following two steps, shown in FIGS. 4-5, comprise the book packager application through which the customized book is assembled and delivered.

When a user selects to continue working on an existing book, the system implements the applicable step last encountered by the user while working on the identified book. When the user elects to start working on a new book, the first step, as illustrated in FIG. 1, is identifying the new book to be created.

During this first step, the user is asked to provide various identifying information about the new book to be created. This information can include a name for the book 101, a client name and/or billing code if the book is being created for a third party client 102/103, and any other identifying attributes which the user desires to assign to the book 104. Once all the specified identification information is entered by the user, the system moves onto the second step 105.

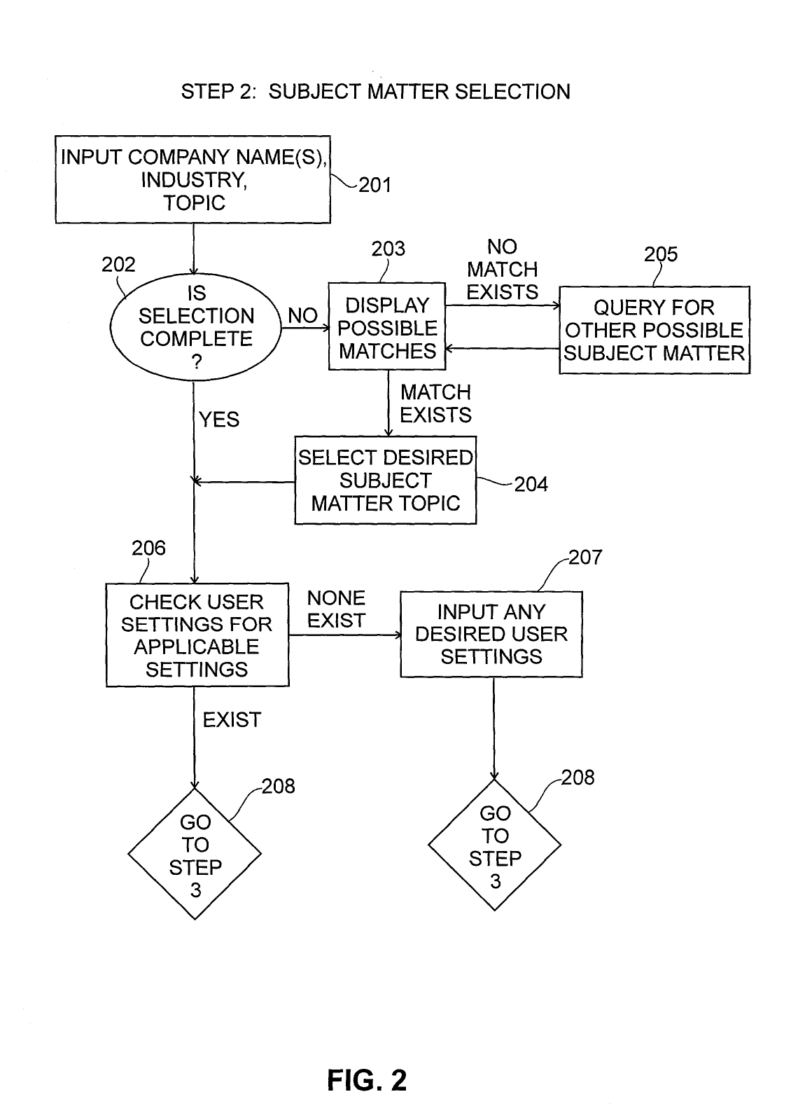

The second step, as illustrated in FIG. 2, is selecting the topic for the book to be created. According to one embodiment, the topic of the book can be only a single company. According to other embodiments, the topic of the book can be multiple companies, a particular industry, or any other topic of interest. The user begins this step by entering a desired topic for the book 201. If the user is unsure of the full name for a company that is the desired topic 202, the user enters a partial name and the system displays a list of possible matches 203 from which the user selects a topic 204. These possible matches are determined by the system after searching all available system databases for any company names that are related to the information entered by the user 201. If the desired selection is not present, the user modifies the search to select other possible topics 205. It should be understood that step 201 optionally could include a menu for the user to check off whether the topic to be identified is a company name, an individual, a type of business, an industry, etc., such that entry of a partial name will result in a more focused search in relevant databases.

Once the user has selected the topic for the book, the system examines the user setting database to determine if any content selection rules exist with regard to the selection and filtering of available content relevant to that topic 206. If no such rules exist, the user is solicited for applicable content selection rules at step 207. Once applicable user settings are determined, the system moves onto the third step 208.

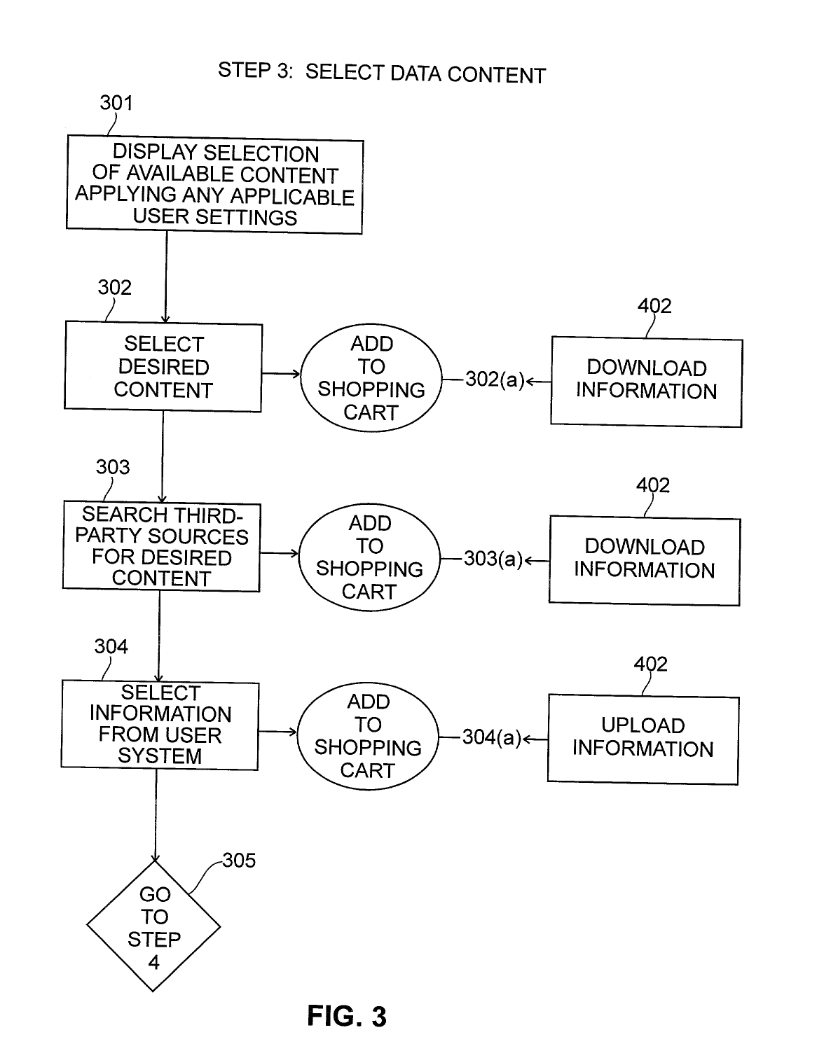

The third step, as illustrated in FIG. 3, is customizing the data content to be added to the new book. The user is provided with a display showing the content available that is relevant to the selected topic 301. The available content depends on the rules derived from the user settings. For example, where the topic is the American Express Company, and the user has requested to view a list of Securities and Exchange Commission filings, and where the user settings limit the available filings for publicly-held corporations to the most recent 10-K filing and the four most recent 10-Q reports, the user application will apply the filter “most recent 10-K and four most recent 10-Q reports” to the list of available filings before display the available content to the user. According to one embodiment, the user application will convert the filter into a query which is understood by the content source, or the user application will retrieve all items on a given topic from the source and apply the filtering logic itself, depending on the content source. According to one preferred embodiment, if the user is dissatisfied with the list of content provided, the user can modify the existing user settings so as to obtain a new list of available content.

Preferably, content is made available to the user from several distinct types of sources. This may include content which is hosted on the system implementing the invention. This system content may be proprietary or may be provided by or licensed from third party vendors. Other content can be provided by third parties outside of the system and accessed through an API. This API is accessed via a code module within the system which converts between the system's internal request formats and the request formats of the API. If this is a proprietary API, the code module (API bridge) is written in order to integrate that third party source. If this is an industry standard API, then existing modules within the system can perform the communication.

Content may also be provided via a URL (World-Wide-Web uniform resource locator). The user provides the URL to the system which then emulates a Web Browser to retrieve this content. In addition, the user may make available to the system implementing the invention, content that is contained on the user's own computer system or intranet, as well as content uploaded by the user by means of a web browser.

From the displayed list of available content sources 301, the user selects the desired content to appear in the book 302. According to one embodiment, the user can elect to add all available content to the book without selecting each item individually from each source. According to another embodiment, the user can elect to have certain default content already selected for the book without the need to select it each time. Where, for example, a user requires certain content to be provided in every book that such user creates, the selection of default content is based on the user settings.

According to a further embodiment, where the user is part of an organization, the list of available content sources 301 is determined based on rules determined at an organization-wide level. According to yet another embodiment of the invention, the content sources selected by the user are stored in a shopping cart after selection until the customized book is created 302(a), 303(a), 304(a). This shopping cart contains all of the meta-data required to uniquely identify a piece of content from a given source. For example, for a source of Market Research content, the meta-data might consist of the accession number of the selected report and range of pages within the report to be retrieved. For a source of Stock Price content, the meta-data might consist of the stock ticker and a range of dates for which to retrieve pricing.

In addition, the user can perform free-form searches to locate additional content from third party locations and accessible through a URL 303. The user thus can utilize online search engines such as Google® or Yahoo!® to locate and download particular information from the internet and then select that information as part of the content to be added to the book. Alternatively, the user can enter a third party internet address from which the information for the book is to be downloaded

According to a further embodiment of the present invention, content can be uploaded from the user's own computer system through a web browser or any other available method 304. Once the user has selected content for the book, the user submits the book, initiating the fourth step 305.

The Book Packager Application

The book packager application comprises two steps which take place once the book is submitted for processing. The first step is creating the customized book. The second step is delivering the customized book. The first step, as illustrated in FIG. 4, is the customized book creation process. Initially, the user may change the ordering of the content for the book, modify the table of contents or separator pages, or change any other user settings in the user settings database 401. Additionally, in an embodiment wherein the finalized book or notification of completion is to be delivered via email, the user can input an email address to which this information is to be sent.

Next, the selected customized content is retrieved 402. According to one embodiment, content retrieval is a multi-threaded processes where multiple threads spawn multiple content applications to simultaneously retrieve the selected data content. For each one of the content selections the user has made, the book packager application spawns a thread which is responsible for fetching the content from the source. This thread uses the meta-data stored in the shopping cart to formulate a request to the content source for the content. There is typically an upper limit placed on the number of threads which may run concurrently to avoid overwhelming the computer system or the content sources with concurrent requests. According to one embodiment, shown at steps 302(a), 303(a) and 304(a), the retrieved content is stored in a shopping cart following retrieval at selection time until the book is ready to be assembled (a).

Additionally, if any rules have been set regarding content selection, for example, to limit the content retrieved according to predetermined criteria such as the date the contents were created, or to exclude content from sources considered unreliable, these setting are applied at step 403. According to one embodiment, the retrieved content is stored in a shopping cart following retrieval until the book is ready to be assembled 302(a), 303(a), 304(a).

The retrieved content may not all be in a single format but, instead, be in multiple formats depending on the source location. Examples of such formats include Adobe Portable Document Format® (PDF), Microsoft Excel®, Microsoft Word®, Rich Text format (RTF), and Hyper-text Mark Up Language (HTML). If multiple file formats exist, all of the files are preferably converted into a single PDF format 404. It will be appreciated by persons of ordinary skill in the field of the invention that formats other than the PDF format may be used. For example, the HTML format may be selected as an alternative. If all of the content is already in a single format, no conversion is necessary.

Once all of the content is in PDF format, the various content is merged into a single PDF format document 405 and the table of contents, instructions for formatting the book, including separator pages, and any other customizations are generated 406 according to any applicable assembly and formatting rules.

The Table of Contents is generated according to the formatting instructions and uses information from the retrieved content such as the title of the content and the number of pages in the content. The formatting rules for the Table of Contents specifies a number of parameters to be used in assembling the content and in constructing the Table of Contents. These rules include the order in which content selections are to be placed in the book, the chapters in the book into which content selections should be placed and whether individual content titles should be listed within the chapters. The rules also include the layout of the Table of Contents including fonts, numbering, indentation, graphics, etc. Separator page rules include similar logic as the Table of Contents and may contain similar types of information for the particular chapter they separate. Cover Sheet rules include how the book is titled, whether there are subtitles containing information on the subject or the book or user who created the book. The Table of Contents, Separator Pages and Cover Sheet may use one or more template files as well to specify the exact placement of graphical content on the page. Typically this will consist of the logos and other branding of the user firm.

Once the final book is assembled and the customized book creation step is completed, the user is notified of the book's completion 407 and the system moves onto the next step 408.

The next step in the book packager application is the book delivery step, illustrated in FIG. 5. According to one embodiment, if a user has entered an email address, the user is sent an email notification 503 after the book is successfully created so that the user can re-enter the system and download the completed book at his own convenience 502. According to a further embodiment, the email contains a web link on which the user can click to re-enter the system directly and download the completed book 501. According to another embodiment, the email notification contains the completed book as an attachment to the email which can be directly accessed by the user 503.

According to any of the three aforementioned embodiments, once the user has retrieved the completed book, the user can print the book at the user's convenience 504. According to a further embodiment, the completed book is delivered electronically to a third party 505 who prints and assembled a hard-copy version of the book according to the formatting instructions 504.

According to one embodiment of the invention, the completed books are stored on the system for 48 hours prior to deletion. According to another embodiment, the time which the completed books remain on the system is a parameter which is individually set by the user prior to creating the book.

The above embodiments are illustrative of the present invention. For example, the sequence in which data is entered by the user may be changed as a matter of design choice, provided that the content related inputs are completed prior tot he generation of the customized book. It is to be understood that the invention is not intended to be limited by this disclosure, but rather is intended to cover various modifications and equivalent arrangements included within the spirit and scope of the invention, as will be apparent to a person of ordinary skill in the art.

We claim:

1. A computerized system for creating, assembling and delivering a customized book, the system comprising:
(a) means for identifying the customized book;
(b) means for selecting at least one topic for the book;
(c) means for soliciting a content selection rule;
(d) means for selecting at least one content source based on the solicited topic;
(e) means for retrieving a plurality of selected content from the at least one content source based on the content selection rule;
(f) means for soliciting an assembly rule;
(g) means for assembling the plurality of selected content wherein the arrangement of the plurality of selected content is based on the assembly rule;
(h) means for soliciting a formatting rule;
(i) means for formatting the plurality of selected content based on the formatting rule; and
(j) means for delivering the customized book.

2. The system of claim 1, wherein the identifying means further comprise means for soliciting a book name.

3. The system of claim 1, wherein the identifying means further comprise means for soliciting a billing code.

4. The system of claim 1, wherein the identifying means further comprise means for soliciting a client name.

5. The system of claim 1, wherein the topic selecting means further comprise means for selecting a single company chosen from a list of a plurality of companies.

6. The system of claim 1, wherein the topic selecting means further comprise means for selecting a single industry chosen from a list of a plurality of industries.

7. The system of claim 1, wherein the topic selecting means further comprise means for selecting a plurality of companies chosen from a list of a plurality of companies.

8. The system of claim 1, wherein the topic selecting means further comprise means for performing a free-form search on the topic.

9. The system of claim 1, wherein the content rule soliciting means further comprise means for soliciting the content rule on a company-wide basis.

10. The system of claim 1, wherein the content rule soliciting means further comprise a database for storing the content rule.

11. The system of claim 1, wherein the content source selecting means further comprise means for selecting content provided by the system.

12. The system of claim 1, wherein the content source selecting means further comprise means for selecting content provided by a user of the system.

13. The system of claim 1, wherein the content source selecting means further comprise means for selecting content provided by a third party source.

14. The system of claim 13, further comprising means for searching the third party source for content.

15. The system of claim 1, wherein the content source selecting means further comprise means for selecting the content source from a list of available content sources.

16. The system of claim 1, wherein the content retrieval means further comprise means for retrieving the content from a computer used by a user of the system.

17. The system of claim 1, wherein the content retrieval means further comprise means for downloading the content from a third party.

18. The system of claim 1, wherein the content retrieval means further comprise means for retrieving the content from the system.

19. The system of claim 1, wherein the content retrieval means further comprise means for placing the retrieved content into a shopping cart.

20. The system of claim 1, wherein the assembly rule soliciting means further comprise means for soliciting the assembly rule on a company-wide basis.

21. The system of claim 1, wherein the assembly rule soliciting means further comprise a database for storing the assembly rule.

22. The system of claim 1, wherein the assembly means further comprise means for converting the retrieved content into a single format.

23. The system of claim 1, wherein the assembly means further comprise means for creating a customized table of contents.

24. The system of claim 1, wherein the assembly means further comprise means for creating at least one separator page.

25. The system of claim 1, wherein the formatting rule soliciting means further comprise means for soliciting the formatting rule on a company-wide basis.

26. The system of claim 1, wherein the formatting rule soliciting means further comprise a database for storing the formatting rule.

27. The system of claim 1, wherein the delivery means further comprise means for notifying the user when the book is complete.

28. The system of claim 1, wherein the delivery means further comprise means for downloading the customized book.

29. The system of claim 1, wherein the content selection rule, the assembly rule, and the formatting rule are selected by the user from a plurality of default settings using a single step.

30. A method for creating, assembling and delivering a customized book, the method comprising the steps of:
(a) identifying the customized book;
(b) selecting at least one topic for the book;
(c) soliciting a content selection rule;
(d) selecting at least one content source based on the solicited topic;
(e) retrieving a plurality of selected content from the at least one content source based on the content selection rule;
(f) soliciting an assembly rule;
(g) assembling the plurality of selected content in an arrangement based on the assembly rule;
(h) soliciting a formatting rule;
(i) formatting the plurality of selected content based on the formatting rule; and
(j) delivering the customized book.

31. The method of claim 30, wherein said identifying step further comprises soliciting a name for the book.

32. The method of claim 30, wherein said identifying step further comprises soliciting a billing code for the book.

33. The method of claim 30, wherein said identifying step further comprises soliciting a client name for the book.

34. The method of claim 30, wherein said topic selecting step further comprises selecting a single company chosen from a list of a plurality of companies.

35. The method of claim 30, wherein said topic selecting step further comprises selecting a single industry chosen from a list of a plurality of industries.

36. The method of claim 30, wherein said topic selecting step further comprises selecting a plurality of companies chosen from a list of a plurality of companies.

37. The method of claim 30, wherein said topic selecting step further comprises performing a free-form search on the topic.

38. The method of claim 30, wherein said content rule soliciting step further comprises soliciting the content rule on a company wide basis.

39. The method of claim 30, wherein said content rule soliciting step further comprises storing the content rule in a database.

40. The method of claim 30, wherein said content source selection step further comprises displaying a list of content sources to a user for selection.

41. The method of claim 30, wherein said content source selection step further comprises selecting content provided by a user.

42. The method of claim 30, wherein said content source selection step further comprises selecting content provided by a third party source.

43. The method of claim 42, further comprising performing a free-form search of the third party source.

44. The method of claim 30, wherein said content source election step further comprises selecting content provided by a computerized system employing the method.

45. The method of claim 30, wherein said content retrieval step further comprises retrieving the content from a user.

46. The method of claim 45, further comprising uploading the content from a computer utilized by the user.

47. The method of claim 30, wherein said content retrieval step further comprises retrieving the content from a third party.

48. The method of claim 47, further comprising downloading the content from a third party web site.

49. The method of claim 30, wherein said content retrieval step further comprises retrieving the content from a computerized system employing the method.

50. The method of claim 30, wherein said content retrieval step further comprises placing the retrieved content in a shopping cart.

51. The method of claim 30, wherein said assembly rule soliciting step further comprises soliciting the assembly rule on a company-wide basis.

52. The method of claim 30, wherein said assembly rule soliciting step further comprises storing the assembly rule in a database.

53. The method of claim 30, wherein said assembly step further comprises converting the retrieved content into a single format.

54. The method of claim 30, wherein said assembly step further comprises creating a customized table of contents.

55. The method of claim 30, wherein said assembly step further comprises creating one or more customized separator pages.

56. The method of claim 30, wherein said formatting rule soliciting step further comprises soliciting the formatting rule on a company-wide basis.

57. The method of claim 30, wherein said formatting rule soliciting step further comprises storing the formatting rule in a database.

58. The method of claim 30, wherein said delivery step further comprises downloading the customized book to a computer used by a user.

59. The method of claim 30, wherein the content selection rule, the assembly rule, and the formatting rule are solicited from the user as a default setting using a single step.
